(19) United States
(12) Patent Application Publication
(10) Pub. No.: US 2009/0237797 A1
(43) Pub. Date: Sep. 24, 2009

(54) Optical Film and Display

(76) Inventor: Wataru Horie, Wakayama (JP)

Correspondence Address: NIXON & VANDERHYE, PC, 901 NORTH GLEBE ROAD, 11TH FLOOR, ARLINGTON, VA, 22203, US

(21) Appl. No.: 11/922,267

(22) PCT Filed: Jun. 1, 2006
(86) PCT No.: PCT/JP2006/310957

§ 371 Date: Dec. 14, 2007

(30) Foreign Application Priority Data
Jun. 23, 2005 (JP) 2005-182800

(51) Int. Cl. G02B 5/02; G02B 1/11

(52) U.S. Cl. 359/586; 359/599

(57) ABSTRACT

An optical film (1) having protrusions and recesses (21A) formed on/in the surface of the film body (20) wherein the distribution of the existence rate of inclination angle θ° of protrusions and recesses (21A) measured by a non-contact three-dimensional micro surface profile measuring system is such that 4°≦|θ|<5° is 1.0% or less, 5°≦|θ|<6° is 0.7% or less, and 6°≦|θ| is 0.1% or less. From the viewpoint of attaining good contrast, maximum existence rate in the distribution of existence rate of the inclination angle θ preferably exists in the range of 0°≦|θ|≦3°. From the viewpoint of attaining high strength, the film body (20) may be fixed onto a polarizing plate (substrate) (30) such that the surface having the protrusions and recesses (21A) is the outside.

### TECHNICAL FIELD

The present invention relates to optical films and display devices. More particularly, the present invention relates to a technology for reducing the whitening of a screen and the lowering of contrast caused by the scattering of external light with a view to obtaining high display quality, and for forming an evenly thick anti-reflection layer on an irregular (non-flat) surface of an optical film.

### BACKGROUND ART

In display devices (and liquid crystal display devices in particular), for the purpose of preventing surface reflection on the display surface, the following technologies have been used singly or in combination: one whereby a low-reflection layer is formed over the target surface to reduce the surface reflection of external light (a reflection reduction technology); and one whereby the target surface is made irregular to scatter external light and thereby reduce the mirroring of external light (a mirroring reduction technology).

According to one example of the mirroring reduction technology mentioned above, in a liquid crystal display device, a transparent resin having beads (microparticles) dispersed in it is applied over the surface of a polarizing plate formed of TAC (triacetyl cellulose). Here, the “heads” of the beads that protrude from the surface of the transparent resin make the surface irregular, and thus the surface scatters external light and thereby prevents it from being mirrored. Inconveniently, however, with this technology, since the mirrored image is simply scattered on an irregular surface and thereby blurred; in a well-lit environment, the entire screen appears whitish, lessening the contrast of black.

In connection with this inconvenience, Patent Document 1 listed below discloses a technology for reducing the whitishness caused by the surface reflection of external light. This document makes the following proposal: with an optical film having a microscopically irregular surface, when light is incident on the target surface from a direction −10° relative to the normal to the film and exclusively the light reflected from the surface is observed, it is preferable that the profile of the reflected light, as observed on the plane including the normal to the film and the direction of incidence of the light, fulfill the relationship

I(30°)/I(10°)≦0.2, with a half-value width of 7° or less.

Here, I(30°) and I(10°) represent the intensity of the reflected light as observed in the direction 30° and 10°, respectively, relative to the normal to the film.

### Patent Document 1: JP-A-2002-365410

### Patent Document 2: JP-A-2004-306328

### DISCLOSURE OF THE INVENTION

### Problems to be Solved by the Invention

As discussed above, the conventional mirroring prevention technology suffers from the lowering of contrast resulting from the whitening of a screen caused by the scattering of external light on an irregular surface, leading to lower display quality.

This inconvenience is addressed by a technology whereby a low-reflection layer is formed over an irregular surface with a view to weakening the reflected light itself. This technology is illustrated in a sectional view in FIG. 8. Here, the thickness of the low-reflection layer (or anti-reflection layer) 10Z needs to be so controlled as to fulfill an optical condition for low reflection (what is generally called the ¼λ) condition). Inconveniently, however, since the inclination angles of the surface irregularities on the underlayer, namely a film 20Z itself, are large, even when an anti-reflection material is applied over the surface irregularities, it runs from elevated spots down and collects in depressed spots. Thus, the low-reflection layer is not formed evenly thick, but becomes unevenly thick (see the thicknesses d1 and d2 in FIG. 8). Accordingly, it is supposed that this low-reflection layer is unlikely to serve its purpose satisfactorily.

On the other hand, as discussed above, Patent Document 1 proposes a technology for reducing the whitening of a screen. In this connection, the inventor of the present invention has studied the distribution of inclination angles in the surface shape disclosed there, and has been able to confirm that the relationship mentioned above is fulfilled satisfactorily. In regard to the whitening reducing effect that this technology offers, however, the inventor has had the impression that it needs further improvement.

In view of the foregoing, an object of the present invention is to provide an optical film that can reduce the whitening of a screen and the lowering of contrast caused by the scattering of external light and that has an irregular surface over which a uniformly thick anti-reflection layer (or low-reflection film) can be formed. Another object of the present invention is to provide a display device that, as a result of its adopting such an optical film, offers high display quality.

### Means for Solving the Problem

To achieve the above objects, according to one aspect of the present invention, in an optical film having surface irregularities (elevations and depressions) formed on the surface of a film proper, the inclination angles θ of the surface irregularities, as measured using a non-contact three-dimensional microscopic surface profile measurement system, exhibit an existence rate distribution such that 1.0% or less of the inclination angles θ fulfill 4°≦|θ|<5°, 0.7% or less of the inclination angles θ fulfill 5°≦|θ|<6°, and 0.1% or less of the inclination angles θ fulfill 6°≦|θ|. With this structure, it is possible to provide an optical film that can reduce the whitening of a screen and the lowering of contrast caused by the scattering of external light and that thereby offers high display quality. Furthermore, with the just mentioned existence rate distribution, even in a case where an anti-reflection layer is laid, by application of its material, over the surface having the surface irregularities formed on it, it can be formed uniformly thick. Thus, it is possible to provide an optical film over the entire surface of which an anti-reflection layer can exert its low-reflection effect.

Throughout the present specification, it should be understood that the inclination angles θ of the surface irregularities formed on the surface of the film proper are measured using a non-contact three-dimensional microscopic surface profile measurement system with the product name “RSTPLUS” manufactured by WYKO Corporation. As shown in FIGS. 9(a) and 9(b), this measurement system measures surface irregularities at x-axis- and y-axis-direction pitches of 0.21 μm, with a z-axis-direction accuracy of ±0.01 μm, and stores the results in the form of x, y, and z coordinates. As shown in FIG. 9(c), in surface irregularities, an imaginary microscopic plane is defined from the data of every three adjacent points, and the normal vector of each such imaginary microscopic plane is calculated. Then, as shown in FIG. 9(d), the angle of the normal vector of each imaginary microscopic plane relative to the z-axis direction is calculated as the inclination angle θ of that imaginary microscopic plane so that, eventually, all the thus calculated inclination angles θ are analyzed to determine the existence rates of different inclination angles θ.

It is preferable that the existence rate distribution of the inclination angles θ be such that the maximum existence rate exists within the range of 0°≦|θ|<3°. With this structure, it is possible to obtain good contrast.

The film proper may be laid over a base material such that the surface of the film proper on which the surface irregularities are formed faces outward. With this structure, it is possible to give the optical film higher strength.

It is preferable that an anti-reflection layer be additionally laid over the surface of the film proper on which the surface irregularities are formed. With this structure, it is possible to provide an optical film that suffers less from reflection on the screen and thus offers higher display quality.

The anti-reflection layer solely may comprise a refractive layer having a lower index of refraction than the film proper. With this structure, it is possible to provide an optical film that is less expensive than one comprising a multiple-layer anti-reflection layer, that exhibits reduced reflectivity even to obliquely incident light, and that is free from coloring caused by the interference of light.

The anti-reflection layer may comprise, laid alternately over one another, at least one refractive layer having a lower index of refraction than the film proper and at least one refractive layer having a higher index of refraction than the film proper. With this structure, it is possible to provide an optical film that exhibits low reflectivity over a wide wavelength range.

According to another aspect of the present invention, a display device comprises the optical film of any one of claims 1 to 6 arranged on the display surface of the display panel proper of the display device. With this structure, it is possible to provide a display device that offers high display quality, with reduced screen whitening and enhanced contrast thanks to the optical film.

### ADVANTAGES OF THE INVENTION

According to the present invention, it is possible to provide an optical film that can reduce the whitening of a screen and the lowering of contrast caused by the scattering of external light and that has an irregular surface over which a uniformly thick anti-reflection layer (or low-reflection film) can be formed. Moreover, according to the present invention, it is also possible to provide a display device that, as a result of its adopting such an optical film, offers high display quality.

### BRIEF DESCRIPTION OF DRAWINGS

FIG. 1 A schematic diagram illustrating a display device embodying the invention.

FIG. 2 An enlarged sectional view of part of a liquid crystal panel embodying the invention.

FIG. 3 An enlarged sectional view of part of an optical film embodying the invention.

FIG. 4 An enlarged sectional view of part of the optical film embodying the invention.

FIG. 5 A schematic diagram illustrating the inclination angle of a microscopic plane on the optical film embodying the invention.

FIG. 6 Schematic diagrams illustrating light-room contrast.

FIG. 7 An enlarged sectional view of part of another optical film embodying the invention.

FIG. 8 A sectional view illustrating an inconvenience experienced with a conventional technology.

FIG. 9 Diagrams illustrating the measurement of the inclination angles of the surface irregularities on the film proper, using a non-contact three-dimensional microscopic surface profile measurement system.

### LIST OF REFERENCE SYMBOLS

1, 1B Optical Film
10, 10B Anti-reflection Layer
11A, 11B High-refraction Layer
12A, 12B Low-refraction Layer
20 Film Proper
21 Irregular Surface
21A Surface Irregularities
22 Flat Surface
50 Display Device
51 Liquid Crystal Panel (Display Panel)
51A Panel Proper
51S Display Surface
θ Inclination Angle

### BEST MODE FOR CARRYING OUT THE INVENTION

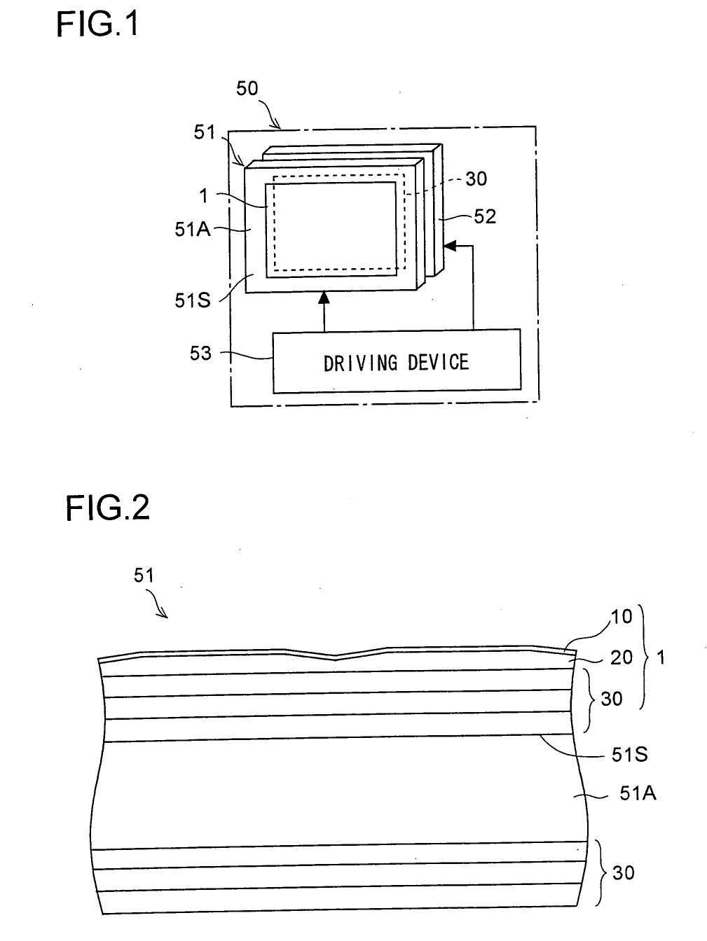

FIG. 1 is a schematic diagram illustrating a display device 50 embodying the present invention. As shown in FIG. 1, the display device 50 includes a liquid crystal panel 51, as an example of a display panel, and a backlight unit (also referred to simply as “backlight”) 52 and a driving device 53. The backlight 52 is arranged at the back of the liquid crystal panel 51, that is, on the side opposite from the display surface 51S, so that the backlight 52 can shine light (backlight) on the liquid crystal panel 51. The driving device 53 is connected to the liquid crystal panel 51 and the backlight 52 to drive and control them. Here, the driving device 53 collectively refers to any circuit, device, etc. that achieve such driving and control. The liquid crystal panel 51 and the backlight 52 may be referred to collectively as the “liquid crystal unit”. Structured as described above, the display device 50 is a liquid crystal display device of the so-called transmissive type.

FIG. 2 is an enlarged sectional view of part of the liquid crystal panel 51. As shown in FIGS. 1 and 2, the liquid crystal panel 51 includes a panel proper 51A, an optical film 1, and a polarizing plate 30. The panel proper 51A may be any liquid crystal panel proper having liquid crystal sealed between mutually facing substrates. The optical film 1 has, laid over the polarizing plate 30 as its base material, a film proper 20 and then an anti-reflection layer 10. Another polarizing plate 30 similar to the one mentioned above is arranged on the surface opposite from the display surface 51S.

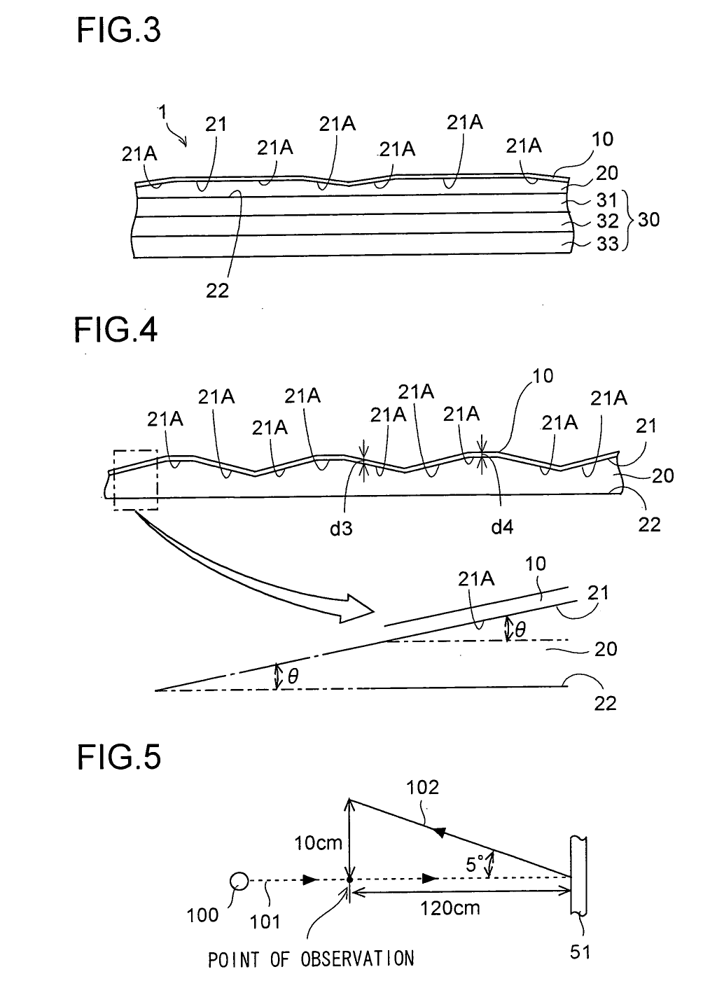

FIGS. 3 and 4 are each an enlarged sectional view of part of the optical film 1. As shown in FIG. 3, the polarizing plate 30 has a first, a second, and a third layer 31, 32, and 33 laid over one another. Examples of the material of the first layer 31 include: cellulose acetate resin such as TAC (triacetyl cellulose); polyester-based resin; polycarbonate resin; polyethersulfon resin, polysulfon resin; polyarylate resin; acrylic resin; cyclic polyolefin resin; and norbonene resin. The second layer 32 is a polarizer, and is formed by dying PVA (polyvinyl alcohol) with iodine and then drawing it into a film to exert a light-polarizing effect. The third layer 33 is the same as the first layer 31. The optical film 1 is laid over the panel proper 51A such that the third layer 33 faces the panel proper 51A. Although unillustrated, an optical compensation layer may additionally be laid between the polarizer plate 30 and the liquid crystal panel 51, and another between the polarizer plate 30 and the panel proper 51A.

As shown in FIGS. 3 and 4, the film proper 20 has an irregular (non-flat) surface 21 and, opposite from it, another surface 22. The surface 22 is flat compared with the irregular surface 21, and can be called a “flat surface 22”. Accordingly, whereas the surface 21 may also be referred to as the “irregular surface 21”, the surface 22 may also be referred to as the “flat surface 22”. The anti-reflection layer 10 is arranged over the irregular surface 21. The film proper 20 is laid over the polarizer plate 30 such that the surface 22 faces the first layer 31 of the polarizer plate 30.

Put in more detail, the film proper 20 has, on the irregular surface 21, many surface irregularities (elevations and depressions) 21A, with every two adjacent surface irregularities 21A connected to each other at their edge. The surface irregularities 21A are sufficiently smaller than the pixel size (for example, 140×400 μm), and are, for example, one-hundredth or less of the pixel size. Here, it is important that the inclination angles θ of the surface irregularities 21A, as measured using the measurement system mentioned previously, exhibit an existence rate distribution such that 1.0% or less of the inclination angles θ fulfill 4°≦|θ|<5°, 0.7% or less of the inclination angles θ fulfill 50≦|θ|<6°, and 0.1% or less of the inclination angles θ fulfill 6°≦|θ|.

The film proper 20 is formed, for example, as follows. A liquid composition containing a polymer, a curable resin precursor, and a solvent is applied over the polarizer plate 30; then the solvent is evaporated; then a phase-separated structure is formed by spinodal decomposition; then the precursor is cured by irradiation of light, and thereby surface irregularities are formed (see Patent Document 2). Here, in an ideal case in which the surface irregularities have a periodic structure consisting of identical units, it is possible, by calculating the period and height of the surface irregularities, to determine the maximum inclination angle. The sectional profile of the surface irregularities are considered to be controllable by the combination of the materials that are subjected to spinodal decomposition; thus, through appropriate control, the film proper 20 can be produced with the above-mentioned preferable existence rate distribution of the inclination angles.

FIG. 5 is a schematic diagram illustrating the inclination angles of the surface irregularities 21A. The inclination angles of the surface irregularities 21A (and hence the distribution of those inclination angles) are designed on the assumption that the liquid crystal display device 50, which has a 30-inch screen, is viewed at the standard distance, that is, the distance from which the liquid crystal panel 51 is recommended to be viewed, specifically at the distance (here, 120 cm) three-times the vertical dimension of the screen. In this case, it has been confirmed, through visual evaluation, that, even when a light source 100 (which is here, for the sake of simplicity, assumed to be a point light source) is mirrored in a corner of the screen, if the scattering of the mirrored light is within a radius of about 10 cm or less, half of the screen remains appearing black, offering enough contrast.

Accordingly, on the assumption that the scattering of the mirrored light source 100 within a radius of about 10 cm or less is acceptable, the distribution of the inclination angles of the surface irregularities 21A is designed. Specifically, the angle between the light 101 from the light source 100 and its reflection from the screen, namely light 102, is calculated as tan⁻¹ (the radius of scattering/the distance from the screen), the angle being, in the case described just above, 5°. This angle of 5° is obtained when the inclination of the screen surface, that is, the inclination angle θ of the surface irregularities 21A, is 2.5°. Thus, it is preferable that the distribution of the inclination angles θ of the surface irregularities 21A have the maximum existence rate within the range of 0°≦|θ|<3°, and this is considered to allow the intensity of the reflection to scatter with the center (peak) at about |θ|=2°.

Back in FIGS. 3 and 4, the anti-reflection layer 10 is formed of a material having a lower index of refraction than the film proper 20. The anti-reflection layer 10 may be composed of a multiple layers as will be described later (see the anti-reflection layer 10B shown in FIG. 7), but here it is composed of one (a single) low-refraction layer. This anti-reflection layer 10 is less expensive than one composed of multiple layers. In addition, since obliquely incident light is less likely to fall outside the optimal low-refraction condition, the anti-reflection layer 10 achieves satisfactory reduction of reflectivity; it is also free from coloring caused by the interference of light.

The anti-reflection layer 10 is formed by applying, over the irregular surface 21, a solution containing a low-refraction material having a lower index of refraction than the film proper 20, then drying it, and then curing it. Even though the anti-reflection layer 10 is formed by application of its material in this way, since the inclination angles θ of the surface irregularities 21A on the underlayer, namely the irregular surface 21, exhibit the distribution described above, that is, since the inclination angles θ are gentle, the anti-reflection layer 10 can be given a uniform thickness over the entire optical film 1 (see the thicknesses d3 and d4 in FIG. 4). Thus, the anti-reflection layer 10 can be formed to fulfill the optical condition for low reflection (what is generally called the ¼λ) condition), with the result that high anti-reflection performance is obtained over the entire optical film 1.

For example, in a case where the anti-reflection layer 10 is formed of “LR-202B” manufactured by Nissan Chemical Industries, Ltd, it has an index of refraction of n₁₀=1.39. In this case, for n₁₀×d to fulfill the ¼λ condition for light having a wavelength of λ=550 nm, the anti-reflection layer 10 needs to have a thickness of d₃ m.

The indices of refraction n₁₀, n₂₀, and n₃₁ of the anti-reflection layer 10, the film proper 20, and the first layer 31 of the polarizer plate 30, respectively, fulfill the relationships described below. Here, since the first layer 31 of the polarizer plate 30 is typically formed of TAC (with an index of refraction of 1.50), mentioned previously, it is assumed that

n₃₁=1.50. (1)

First, the necessary condition for low reflection is, as mentioned previously,

n₁₀<n₂₀. (2)

Moreover, it is necessary that

n₂₀−n₃₁≦0.2, preferably n₂₀=n₃₁ (3)

be fulfilled. This is because, if the difference between n₂₀ and n₃₁ is greater than 0.2, coloring caused by the interference of light is greater than the permissible level.

Furthermore, it is necessary that

1.22≦n₁₀≦1.45 (4)

be fulfilled. This is because the theory of optical interference dictates that, when a layer laid over a layer having an index of refraction of 1.50 has an index of refraction of 1.22, the minimum reflectivity is obtained, the reflectivity increasing as the index of refraction of the upper layer decreases from 1.22. Specifically, according to formulae (1) and (3), the index of refraction n₂₀ of the film proper 20 is about 1.50; thus, when the anti-reflection layer 10, which is the overlayer over the film proper 20, has an index of refraction of 1.22, the minimum reflectivity is obtained, the reflectivity increasing as the index of refraction of the overlayer decreases from 1.22.

Incidentally, assuming that n₁₀×d₁₀=¼×λ₀, the reflectivity R₁₀ of the anti-reflection layer 10 as observed when light is perpendicularly incident on the optical film 1 from the antireflection layer 10 side is given by

R₁₀=((n₀×n₂₀−n₁₀²)/((n₀×n₂₀+n₁₀²)². (4a)

Here, n₀ represents the index of refraction of air, d₁₀ represents the thickness of the low-refraction layer n₁₀, and λ₀ represents the wavelength of light in vacuum. In this case, when

n₀<n₁₀<n₂₀ and n₀×n₂₀−n₁₀²=0, (4b)

the reflectivity R₁₀ equals 0 (at its minimum). Here, since air has an index of refraction of n₀=1 and the film proper 20 has an index of refraction of n₂₀=1.50 (see formulae (1) and (3)), formula (4a) gives, as mentioned above,

n₁₀=\sqrt{1.50}=1.22.

On the other hand, the reason that formula (4) has its upper limit set at 1.45 is that, in addition to the standpoints on which formulae (1) and (3) are founded, if n₂₀ is greater than 1.45, the reflectivity is so high that the intensity of mirroring is greater than the permissible level.

With samples of the optical film 1 described above, first, the surface irregularity profile on the film proper 20 was measured using a non-contact three-dimensional microscopic surface profile measurement system manufactured by WYKO Corporation to check the existence rate distribution of inclination angles θ. The results are shown in Table 1. The values in Table 1 are the existence rates of different inclination angles θ with respect to the integral for all azimuth angles. For example, the value “40.769” for inclination angles θ of 0° to 1° means that the inclination angles θ that fall within the range of 0° to 1° account for 40.769% of all the inclination angles θ.

TABLE 1

| Inclination | | | |
|---|---|---|---|
| Angle θ | Present Invention - | Present Invention - | Comparative |
| (°) | Sample #1 | Sample #2 | Example |
| 0-1 | 40.769 | 42.817 | 28.430 |
| 1-2 | 43.631 | 39.041 | 38.806 |
| 2-3 | 12.719 | 14.801 | 20.033 |
| 3-4 | 2.141 | 2.585 | 7.332 |
| 4-5 | 0.650 | 0.616 | 2.924 |
| 5-6 | 0.090 | 0.101 | 1.425 |
| 6-7 | 0.000 | 0.030 | 0.600 |
| 7-8 | 0.000 | 0.010 | 0.285 |
| 8-9 | 0.000 | 0.000 | 0.135 |
| 9-10 | 0.000 | 0.000 | 0.030 |
| 10-11 | 0.000 | 0.000 | 0.000 |
| Screen | Good | Good | Poor |
| Whitishness | | | |

Table 1 demonstrates that, in samples #1 and #2 according to the present invention, a irregular surface 21 was obtained that fulfilled the following conditions: 1.0% or less of the inclination angles θ fulfill 4°≦|θ|<5°, 0.7% or less of the inclination angles θ fulfill 50≦|θ|<6°, and 0.1% or less of the inclination angles θ fulfill 6°≦|θ|. Moreover, samples #1 and #2 had reduced screen whitishness and offered good display quality. In the bottommost row of Table 1, “Good” represents a better whitening reducing effect than “Poor”.

The formula mentioned earlier as disclosed in Patent Document 1 can be interpreted as signifying that 20% or less of a surface has an inclination angles of 20°. This is because, when light is reflected on the surface, the angle of reflection is twice the inclination angle. Such a surface, however, is considered to exert rather a poor whitening reducing effect in a well-lit environment.

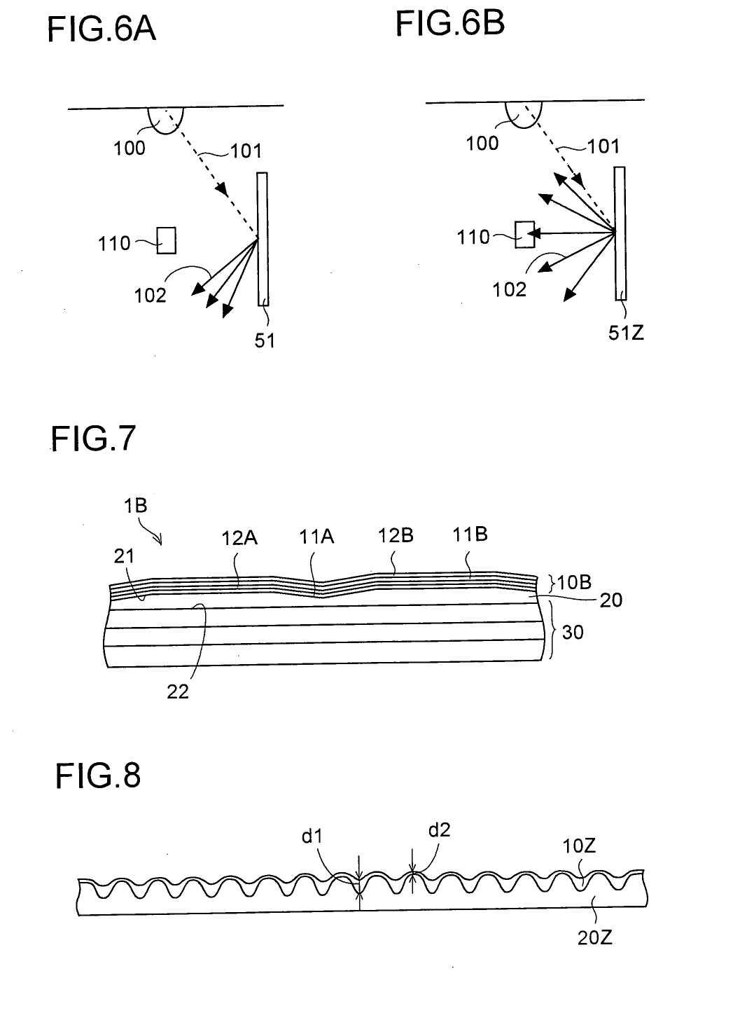

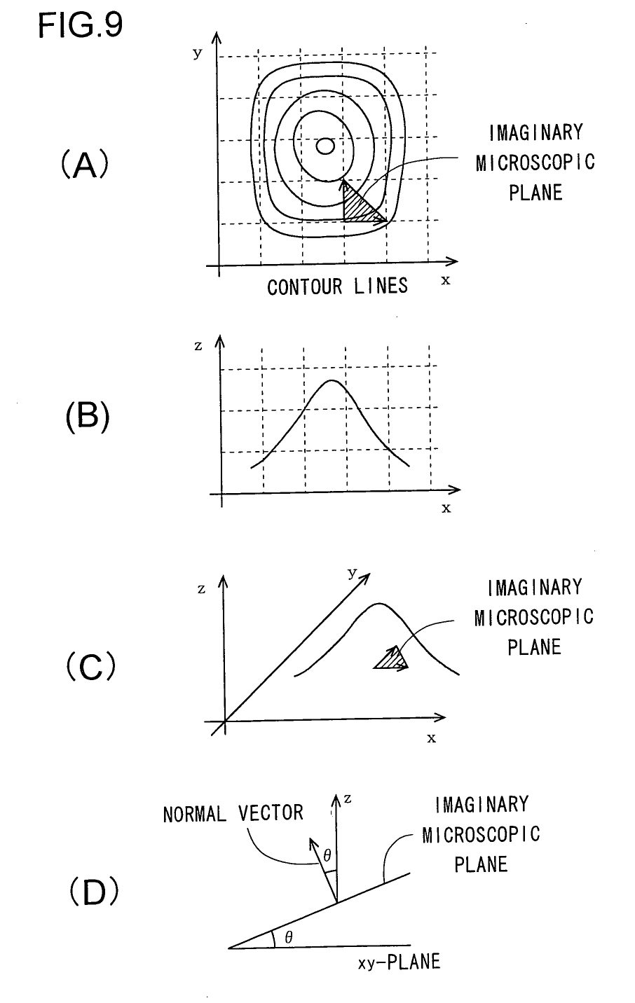

Second, contrast (the ratio of the brightness of black to that of white on the screen) was measured, with the optical film 1 arranged over the left half of the display surface 51S of the panel proper 51A and a polarizing plate having a conventional irregular-surfaced anti-glare layer arranged on the right half. Specifically, as shown in schematic diagrams in FIG. 6, in a room lit with a fluorescent lamp 100 on the ceiling, in an environment in which the illuminance on the surface of the liquid crystal panel was 270 to 300 luxes, using a brightness meter 110 (the “BM-5A” model manufactured by Topcon Corporation), contrast (light-room contrast) was measured in the direction normal to the front face, that is, the display surface 51S, of the panel. In this environment, the fluorescent lamp was not directly mirrored. The measurement revealed that, whereas the light-room contrast with the conventional structure was 261, the light-room contrast with the optical film 1 was 376. That is, the optical film 1 offered 44% increased light-room contrast, and was confirmed to exert a whitening reducing effect.

This difference in contrast arises as follows. As shown in FIG. 6(b), with the conventional structure, the light 101 from the fluorescent lamp 100 is scattered at a wide angle by the anti-glare (irregular-surfaced) layer on the surface of the liquid crystal panel 51Z, and thus the scattered light 102 enters the brightness meter 110, resulting in increased brightness. In contrast, as shown in FIG. 6(a), with the liquid crystal panel 51 provided with the optical film 1, the light 101 from the fluorescent lamp 100 is scattered at a small angle on the surface of the liquid crystal panel 51, and thus the scattered light 102 does not enter the brightness meter 110, resulting in high contrast.

Next, with the optical film 1 according to the present invention and with, as a comparative example, the conventional anti-glare layer, reflectivity was measured at surface irregularities, that is, at elevated and depressed spots on the surface. The results are shown in Table 2. Measurements were made each in a region with a diameter of 25 μm, using a device for measuring the reflectivity in a microscopic region (the model “OSP100” manufactured by Olympus Corporation).

TABLE 2

| Reflected Y Value | Present Invention | Comparative Example |
|---|---|---|
| Elevations | 2.09 | 2.82 |
| Depressions | 2.09 | 2.63 |
| Reflectivity Difference | 0 | 0.19 |
| Evaluation | Good | Fair |

Table 2 shows that, with the optical film 1, there is no difference in reflectivity between at the elevated and depressed spots, indicating that the anti-reflection layer 10 is formed uniformly thick. In the bottommost row of Table 2, “Good” represents a better uniformity in the thickness of the low-refraction layer than “Fair”. In Table 2, “Reflected Y Value” refers to the Y value of the tristimulus values of a color of a reflective object as located in a two-degree field-of-view XYZ system according to Japanese Industrial Standard (JIS) Z8701.

As described above, with the optical film 1, thanks to the film proper 20, it is possible to reduce the whitening of a screen and the lowering of contrast caused by the scattering of external light; moreover, thanks to the anti-reflection layer 10, it is possible to reduce reflection on the screen. Thus, the display device 50, incorporating the optical film 1, offers high display quality.

FIG. 7 is an enlarged sectional view of part of another optical film 1B embodying the present invention. This optical film 1B can be used in place of the optical film 1 described above in the display device 50 (see FIG. 1). As shown in FIG. 7, in the optical film 1B, the anti-reflection layer 10 provided in the optical film 1 described above (see FIG. 3) is replaced with an anti-reflection layer 10B.

The anti-reflection layer 10B has, laid over one another on the irregular surface 21, a high-refraction layer 11A, a low-refraction layer 12A, a high-refraction layer 11B, and a low-refraction layer 12B. That is, the anti-reflection layer 10B has high-refraction and low-refraction layers laid alternately over one another in two cycles. The high-refraction layers 11A and 11B have an index of refraction higher than the film proper 20, and the low-refraction layers 12A and 12B have an index of refraction lower than the film proper 20.

With this optical film 1B, as with the previously described optical film 1, it is possible to reduce the whitening of a screen and the lowering of contrast caused by the scattering of external light, and also to reduce reflection on the screen. What is particular here is that the anti-reflection layer 10B, which has layers having different indices of refraction laid alternately over one another, exhibits reduced reflectivity in a wide wavelength range. Although the anti-reflection layer 10B has four layers in the example shown in FIG. 7, there is no restriction on the number of layers of which the anti-reflection layer 10B is composed; that is, needless to say, it may be composed of two layers, or three layers, or five or more layers.

Although the above description deals with cases in which the display device 50 is a liquid crystal display device of the so-called transmissive type, it should be understood that the optical films 1 and 1B can be applied to liquid crystal display devices of the reflective type, and to those of the semi-transmissive type, that is, the type in which the principles of the reflective and transmissive types are combined together. The optical films 1 and 1B can be applied not only to liquid crystal display devices but even to other types of display devices such as plasma display devices. In such cases, for example, in a display device like a plasma display device, which requires no polarizer plate 30, the polarizer plate 30 as a base material is omitted so that the optical film is composed of the film proper 20 and the anti-reflection layer 10. Alternatively, the optical film may have the film proper 20 and the anti-reflection layer 10 formed over a base material such as a base film.

### INDUSTRIAL APPLICABILITY

With an optical film according to the present invention, it is possible to reduce the whitening of a screen and the lowering of contrast caused by the scattering of external light, and, by using it in a display device, it is possible to obtain high display quality. Moreover, even in a case where an anti-reflection layer is additionally laid, by application of its material, over the surface of the film proper included in the optical film according to the present invention, it is possible to form the anti-reflection layer uniformly thick. Thus, with the optical film according to the present invention, the anti-reflection layer can exert its low-reflection effect over the entire surface.

1. An optical film having surface irregularities formed on a surface of a film proper, wherein inclination angles θ of the surface irregularities, as measured using a non-contact three-dimensional microscopic surface profile measurement system, exhibit an existence rate distribution such that
1.0% or less of the inclination angles θ fulfill 4°≦|θ|<5°,
0.7% or less of the inclination angles θ fulfill 5°≦|θ|<6°, and
0.1% or less of the inclination angles θ fulfill 6°≦|θ|.

2. The optical film of claim 1, wherein a maximum existence rate exists in a range of 0°≦|θ|<3°.

3. The optical film of claim 1, wherein the film proper is laid over a base material such that the surface of the film proper on which the surface irregularities are formed faces outward.

4. The optical film of claim 1, wherein an anti-reflection layer is additionally laid over the surface of the film proper on which the surface irregularities are formed.

5. The optical film of claim 4, wherein the anti-reflection layer solely comprises a refractive layer having a lower index of refraction than the film proper.

6. The optical film of claim 4, wherein the anti-reflection layer comprises, laid alternately over one another, at least one refractive layer having a lower index of refraction than the film proper and at least one refractive layer having a higher index of refraction than the film proper.

7. A display device comprising the optical film of claim 1, arranged on a display surface of a display panel proper of the display device.
